(19) United States
(12) Patent Application Publication
(10) Pub. No.: US 2009/0189828 A1
(43) Pub. Date: Jul. 30, 2009

(54) DEVICE, METHOD AND SYSTEM OF RECEIVING MULTIPLE-INPUT-MULTIPLE-OUTPUT COMMUNICATIONS

(76) Inventors: Roman Shmulevich, Hertzeliya (IL); Shlomo Arbel, Shoham (IL)

Correspondence Address: EMPK & Shiloh, LLP;c/o Landon IP, Inc., 1700 Diagonal Road, Suite 450, Alexandria, VA, 22314, US

(21) Appl. No.: 12/020,594

(22) Filed: Jan. 28, 2008

(51) Int. Cl. H01Q 3/24; H01Q 21/00

(52) U.S. Cl. 343/876; 343/893

(57) ABSTRACT

Some demonstrative embodiments include devices, systems and/or methods of multiple-input-multiple-output wireless communication. Some embodiments include an apparatus having a wireless receiver to receive a multiple-input-multiple-output wireless transmission, the receiver including a set of antenna elements having different polarizations to receive a respective set of wireless signals of the multiple-input-multiple-output wireless transmission over a respective set of different communication channels, wherein the set of antenna elements includes a first number of antenna elements; a radio-frequency module to handle a second number of wireless received signals, wherein the second number is smaller than the first number; and a selector to selectively provide the radio-frequency module with a subset of the set of wireless signals including the second number of signals according to at least one selection criterion. Other embodiments are described and claimed.

### FIELD

Some embodiments relate generally to the filed of wireless communication and, more particularly, to multiple-input-multiple-output wireless communication.

### BACKGROUND

Wireless communication has rapidly evolved over the past decades. Even today, when high performance and high bandwidth wireless communication equipment is made available there is demand for even higher performance at a higher data rates, which may be required by more demanding applications.

A Multiple-input- multiple-output (MIMO) communication scheme, implementing multiple antennas at both a transmitter and a receiver, may result in an increase in data throughput and/or link range, e.g., without additional bandwidth or transmit power.

### SUMMARY

Some demonstrative embodiments include systems and/or methods of multiple-input-multiple-output wireless communication.

Some demonstrative embodiments include an apparatus including a wireless receiver to receive a multiple-input-multiple-output wireless transmission, wherein the receiver includes a set of antenna elements having different polarizations to receive a respective set of wireless signals of the multiple-input-multiple-output wireless transmission over a respective set of different communication channels, wherein the set of antenna elements includes a first number of antenna elements; a radio-frequency module to handle a second number of wireless received signals, wherein the second number is smaller than the first number; and a selector to selectively provide the radio-frequency module with a subset of the set of wireless signals including the second number of signals according to at least one selection criterion.

In some demonstrative embodiments, the selector is capable of determining a plurality of values of a predefined parameter relating to a plurality of subsets of the set of antenna elements, respectively, wherein each of the subsets includes the second number of antenna elements; and selecting a subset of the plurality of subsets by applying the selection criterion to the plurality of values.

In some demonstrative embodiments, the selector is capable of selecting another subset of the plurality of subsets of antenna elements, if the value of the parameter exceeds a predefined threshold value.

In some demonstrative embodiments, the set of antenna elements includes a plurality of pairs of antenna elements. The selector may include a plurality of switches to switch between the antenna elements of the plurality of pairs of antenna elements, respectively.

In some demonstrative embodiments, the receiver may include a controller to control the set of switches based on the at least one selection criterion.

In some demonstrative embodiments, the controller is capable of determining a plurality of values of a predefined parameter relating to a plurality of subsets of the set of antenna elements, respectively, wherein each of the subsets includes the second number of antenna elements; selecting a subset of the plurality of subsets by applying the selection criterion to the plurality of values; and controlling the set of switches to switch to the selected subset of antenna elements.

In some demonstrative embodiments, the set of antenna elements may include a first antenna array including a plurality of antenna elements of a first type, and a second antenna array including a plurality of antenna elements of a second type.

In some demonstrative embodiments, each of the first and second antenna arrays includes the second number of antenna elements, and the selector may include a set of switches, each of the switches to switch between an antenna element of the first antenna array and an antenna element of the second antenna array.

In some demonstrative embodiments, the first antenna array includes a plurality of printed inverted-F-antenna-elements, and the second antenna array includes a plurality of planar-inverted-f-antenna elements.

In some demonstrative embodiments, the at least one selection criterion is related to at least a noise gain of the subset of wireless signals.

In some demonstrative embodiments, the apparatus may include a display to display an image corresponding to the multiple-input-multiple-output wireless transmission.

Some demonstrative embodiments include a method of receiving a multiple-input-multiple-output wireless transmission, the method may include receiving a set of wireless signals of the multiple-input-multiple-output wireless transmission over a respective set of different communication channels via a respective set of antenna elements, wherein the set of antenna elements may include a first number of antenna elements having different polarizations; selecting a subset of the set of wireless signals including a second number of signals according to at least one selection criterion; and providing a radio-frequency module with the subset of wireless signals.

In some demonstrative embodiments, the selecting may include determining a plurality of values of a predefined parameter relating to a plurality of different subsets of the set of antenna elements, respectively, wherein each of the subsets includes the second number of antenna elements; and applying the selection criterion to the plurality of values.

In some demonstrative embodiments, the method may include switching from a selected subset of the plurality of subsets of antenna elements to another subset of the plurality of subsets of antenna elements, if the value of the parameter exceeds a predefined threshold value.

In some demonstrative embodiments, the parameter relates to a noise gain of the subsets.

In some demonstrative embodiments, the set of antenna elements includes a plurality of pairs of antenna elements, and the selecting may include switching between first and second antenna elements of one or more of the pairs of antenna elements.

In some demonstrative embodiments, the set of antenna elements may include a first antenna array including a plurality of antenna elements of a first type, and a second antenna array including a plurality of antenna elements of a second type.

In some demonstrative embodiments, a first half of the subset of antenna elements may include antenna elements of the first type, and a second half of the subset of antenna elements may include antenna elements of the second type.

In some demonstrative embodiments, the first antenna array includes a plurality of printed inverted-F-antenna-elements, and the second antenna array includes a plurality of planar-inverted-f-antenna elements.

Some demonstrative embodiments include a system, which may include a transmitter to transmit a multiple-input-multiple-output wireless transmission; and a receiver to receive the wireless transmission. The receiver may include a set of antenna elements having different polarizations to receive a respective set of wireless signals of the wireless transmission over a respective set of different communication channels, wherein the set of antenna elements includes a first number of antenna elements; a radio-frequency module to handle a second number of wireless received signals, wherein the second number is smaller than the first number; and a selector to selectively provide the radio-frequency module with a subset of the set of wireless signals including the second number of signals according to at least one selection criterion.

In some demonstrative embodiments, the selector is capable of determining a plurality of values of a predefined parameter relating to a plurality of subsets of the set of antenna elements, respectively, wherein each of the subsets includes the second number of antenna elements; and selecting a subset of the plurality of subsets by applying the selection criterion to the plurality of values.

In some demonstrative embodiments, the set of antenna elements includes a plurality of pairs of antenna elements, and the selector may include a plurality of switches to switch between the antenna elements of the plurality of pairs of antenna elements, respectively.

In some demonstrative embodiments, the set of antenna elements may include a first antenna array including a plurality of antenna elements of a first type, and a second antenna array including a plurality of antenna elements of a second type.

In some demonstrative embodiments, the system may include a video source associated with the transmitter to generate video data, wherein the wireless video transmission represents the video data; and a display associated with the receiver to display an image corresponding to the video data.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. Moreover, some of the blocks depicted in the drawings may be combined into a single function. The figures are listed below.

FIG. 1 is a schematic illustration of a wireless Multiple-Input-Multiple-Output (MIMO) communication system in accordance with some demonstrative embodiments;

FIG. 2 is a schematic illustration of a wireless MIMO receiver in accordance with some demonstrative embodiments;

FIG. 3 is a schematic flow-chart illustration of a method of initializing a plurality of subsets of antenna elements, in accordance with some demonstrative embodiments; and

FIG. 4 is a schematic flow-chart illustration of a method of switching between subsets of antenna elements, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing,” “computing,” “calculating,” “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing Institute-of-Electrical-and-Electronics-Engineers (IEEE) 802.15, IEEE 802.15.3c, WirelessHD (WiHD), and/or Ecma TG20 standards and/or future versions and/or derivatives and/or Long Term Evolution (LTE) of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Cairier Modulation (MDM), Discrete Multi-Tone (DMT), Bluetooth, Global Positioning System (GPS), Wi-Fi, Wi-Max, ZigBee™, WiHD, Ultra-Wideband (UWB), Global System for Mobile communication (GSM), 2G, 2.5G, 3G, 3.5G, or the like. Some embodiments may be used in various other devices, systems and/or networks.

It should be understood that some embodiments may be used in a variety of applications. Although embodiments of the invention are not limited in this respect, one or more of the methods, devices and/or systems disclosed herein may be used in many applications, e.g., civil applications, military applications or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, embodiments of the invention are not limited in this respect and some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

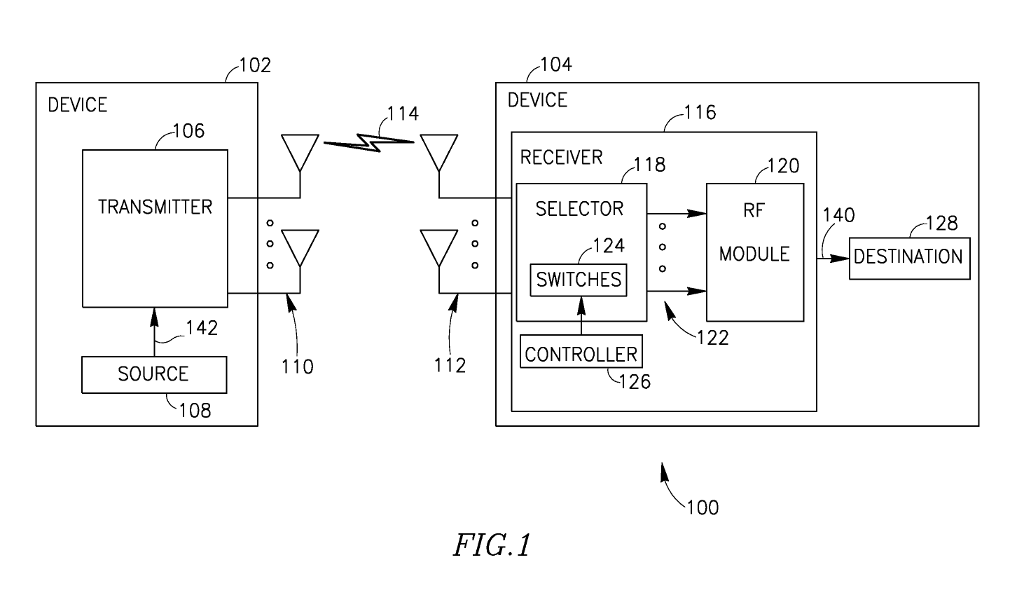

Reference is made to FIG. 1, which schematically illustrates a Multiple-Input-Multiple-Output (MIMO) wireless communication system 100, in accordance with some demonstrative embodiments.

In some demonstrative embodiments, receiver 116 may include a set of antenna elements 112 having different polarizations to receive a respective set of wireless signals of a wireless MIMO transmission 114 over a respective set of different communication channels, e.g., as described in detail below.

In some demonstrative embodiments, the set of antenna elements 112 may include a first number, denoted n, of antenna elements. In one non-limiting example, the set of antenna elements 112 may include ten antenna elements, e.g., as described in detail below. In other embodiments the set of antenna elements 112 may include any other suitable number of antenna elements, e.g., n≧3.

In some demonstrative embodiments, receiver 116 may also include a radio-frequency (RF) module 120 to handle a second number, denoted m, of wireless received signals, wherein m<n. In one non-limiting example, RF module 120 may be capable of handling five wireless received signals, e.g., as described below. In other embodiments, RF module 120 may be capable of handling any other suitable number of wireless received signals.

In some demonstrative embodiments, receiver 116 may also include a selector 118 to selectively provide RF module 120 with a subset 122 of the set of wireless signals, according to at least one selection criterion. The at least one selection criterion may be related, for example, to a value of at least one predefined selection parameter, e.g., as described in detail below.

In some demonstrative embodiments, the subset of wireless received signals 122 may include m out of the n wireless signals received via the set 112 of n antenna elements, respectively. In one non-limiting example, selector 118 may selectively provide RF module 120 with subset 122 including five wireless signals received via a subset of five respective antenna elements of the set of antenna elements 112.

In some demonstrative embodiments, selector 118 may determine a plurality of values (“selection values”) of the selection parameter relating to a respective plurality of subsets of m antenna elements out of the set of antenna elements 112; and select a subset of the plurality of subsets, by applying the selection criterion to the plurality of selection values, e.g., as described below.

In some demonstrative embodiments, the plurality of subsets of antenna elements may include a predefined number, denoted Nsubsets, of subsets corresponding, for example, to a predefined number of combinations of antenna elements of set 112, e.g., as described below.

In some demonstrative embodiments, selector 118 may switch between a first subset of antenna elements (“the currently selected subset”) and a second subset of antenna elements, e.g., if the value of the selection parameter corresponding to the currently selected subset exceeds a predefined range of values, e.g., as described in detail below.

In some demonstrative embodiments, the set of antenna elements 112 may include antenna elements of any suitable type and/or any suitable arrangement or combination of antenna elements, e.g., as described below.

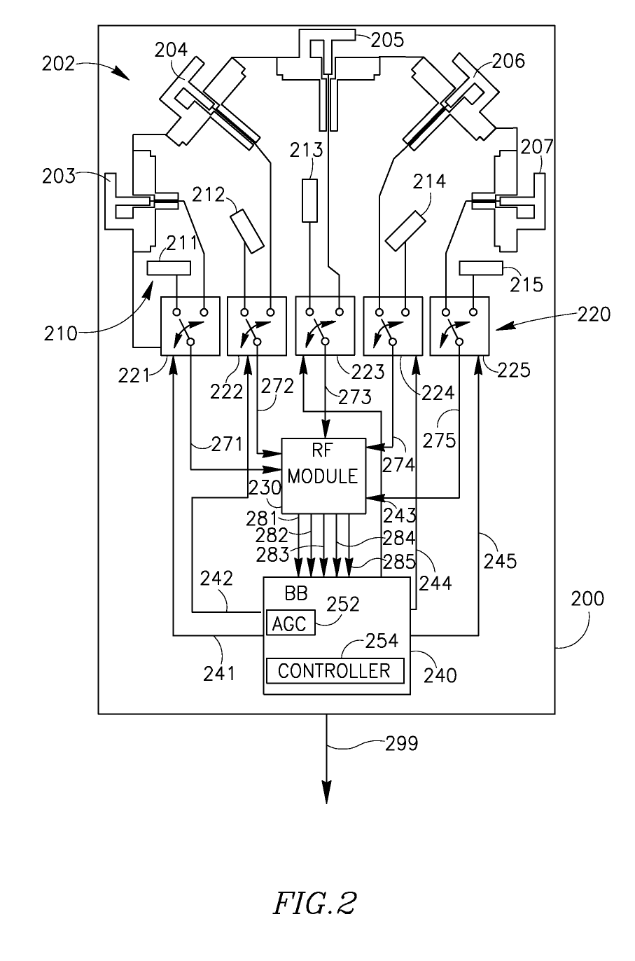

In some demonstrative embodiments, the set of antenna elements 112 may include a plurality of pairs of antenna elements, e.g., m pairs of antenna elements, if n=m*2. For example, the plurality of subsets may include 2^{m} subsets of antenna elements corresponding to 2^{m} different combinations of m antenna elements including an antenna element of each of the m pairs of antenna element, e.g., 32 subsets of antenna elements if m=5 and n=10. According to these embodiments, selector 118 may include a plurality of switches 124 to switch between antenna elements of the plurality of pairs of antenna elements, e.g., as described below with reference to FIG. 2.

In other embodiments, the set of antenna elements 112 may include any other suitable arrangement of antenna elements of any suitable one or more types, and/or selector 118 may include one or more switches to switch between one or more combinations and/or subsets of the antenna elements. For example, selector 118 may include one or more switches to select between nl/ml subsets of antenna elements corresponding to nl/ml different combinations of m antenna elements out of the n antenna elements.

In some demonstrative embodiments, receiver 116 may include a controller 126 to control the operation of selector 118. In one example, controller 126 may be implemented as part of selector 118. In another example, controller 126 may be implemented as part of any suitable unit, module or element of receiver 116, e.g., as part of a Base-Band (BB) module of receiver 116 as described below.

In some demonstrative embodiment, controller 126 may be capable of controlling switches 124 based on the selection criterion. For example, in some demonstrative embodiments, controller 126 may determine the plurality of selection values of the selection parameter relating to the plurality of subsets of antenna elements, respectively; select a subset of the plurality of subsets by applying the selection criterion to the plurality of selection values; and control switches 124 to switch to the selected subset of antenna elements, e.g., as described below.

In some demonstrative embodiments, the set of antenna elements 112 may include antenna elements of two or more different types. In one example, the set of antenna elements 112 may include at least a first antenna array including a plurality of antenna elements of a first type, and a second antenna array including a plurality of antenna elements of a second type, e.g., as described below with reference to FIG. 2.

In some demonstrative embodiments, each of the first and second antenna arrays may include m antenna elements, e.g., as described below with reference to FIG. 2.

In some demonstrative embodiments, the first antenna array may include a plurality of printed inverted-F-antenna (IFA) elements, and/or the second antenna array may include a plurality of planar-inverted-f-antenna (PIFA) elements, e.g., as described below with reference to FIG. 2.

In some demonstrative embodiments, each of switches 124 may switch, for example, between an antenna element of the first antenna array and an antenna element of the second antenna array.

In some demonstrative embodiments, receiver 116 may provide output signals 140 corresponding to transmission 114. Receiver 116 may be associated with a destination module 128 capable of handling signals 140, e.g., as described below.

In some demonstrative embodiments, receiver 116 may be implemented as part of a transceiver, a transmitter-receiver, or other suitable component. In some embodiments, receiver 116 may be implemented as part of a Medium Access Control (MAC) layer, a physical (PHY) layer, and/or any other suitable communication layer or configuration.

In some demonstrative embodiments, receiver 116 and/or destination module 128 may be implemented as part of a destination device 104. In some embodiments, some or all of the components of device 104 may be enclosed in a common housing, packaging, or the like, and may be interconnected or operably associated using one or more wired or wireless links. In other embodiments, components of device 104 may be distributed among multiple or separate devices or locations.

In some demonstrative embodiments, system 100 may also include a wireless MIMO transmitter 106 having a plurality of antennas 110, including l antennas, to transmit MIMO transmission 114 based on input signals 142. Transmitter 116 may include any suitable MIMO transmitter. Transmitter 106 may be associated with a source module 108 capable of generating signals 142, e.g., as described below.

In some demonstrative embodiments, transmitter 106 may be implemented as part of a transceiver, a transmitter-receiver, or other suitable component. In some embodiments, transmitter 106 may be implemented as part of a Medium Access Control (MAC) layer, a physical (PHY) layer, and/or any other suitable communication layer or configuration.

In some demonstrative embodiments, transmitter 106 and/or source module 108 may be implemented as part of a source device 102. In some embodiments, some or all of the components of device 102 may be enclosed in a common housing, packaging, or the like, and may be interconnected or operably associated using one or more wired or wireless links. In other embodiments, components of device 102 may be distributed among multiple or separate devices or locations.

In some demonstrative embodiments, system 100 may include a wireless video communication system. For example, source module 108 may include a video source, transmitter 106 may include a wireless video transmitter, receiver 116 may include a wireless video receiver, and destination 128 may include a video destination, e.g., as described below.

In some demonstrative embodiments, source 108 may include any suitable video generator to generate signals 142 including video data in any suitable video format to be displayed by destination 128. For example, source 108 may generate signals 142 including HDTV video signals, for example, uncompressed HDTV signals, e.g., in a Digital Video Interface (DVI) format, a High Definition Multimedia Interface (HDMI) format, a Video Graphics Array (VGA), a VGA DB-15 format, an Extended Graphics Array (XGA) format, and their extensions, or any other suitable video format. Device 102 and/or source 108 may include any suitable video software and/or hardware, for example, a portable video source, a non-portable video source, a Set-Top-Box (STB), a DVD, a digital-video-recorder, a game console, a PC, a portable computer, a Personal-Digital-Assistant, a Video Cassette Recorder (VCR), a video camera, a cellular phone, a television (TV) tuner, a photo viewer, a media player, a video player, a portable-video-player, a portable DVD player, an MP-4 player, a video dongle, a cellular phone, and the like.

Although embodiments of the invention are not limited in this respect, according to some demonstrative embodiments transmission 114 may represent a plurality of transformation coefficients corresponding to the video data of signals 142. For example, transmitter 106 may apply a de-correlating transformation, e.g., a DCT and/or a wavelet, to signals 142, e.g., as described in U.S. patent application Ser. No. 11/551,641, entitled “Apparatus and method for uncompressed, wireless transmission of video”, filed Oct. 20, 2006, and published May 3, 2007, as U.S. Patent Application Publication US 2007-0098063 (“the '641 Application”), the entire disclosure of which is incorporated herein by reference. For example, transmitter 106 may perform the de-correlating transform on a plurality of color components, e.g., in the format Y-Cr-Cb, representing pixels of signals 142, as described in the '641 Application. In some demonstrative embodiments, transmission 114 may include values of fine constellation symbols, and values of coarse constellation symbols, e.g., as described in the '641 Application.

In some demonstrative embodiments, receiver 116 may perform the functionality of a wireless video receiver, e.g., as described in the '641 Application, to generate signals 140 including video data corresponding to video signals 142. Destination 128 may include any suitable software and/or hardware to receive, process, store, and/or handle signals 140 in any suitable manner. In one example, device 104 and/or destination 114 may include any suitable video display and/or receiver, for example, a display or screen, e.g., a flat screen display, a Liquid Crystal Display (LCD), a plasma display, a back projection television, a television, a projector, a monitor, an audio/video receiver, a video dongle, and the like.

In some demonstrative embodiments, devices 102 and/or 104 may be or may include any suitable wireless communication devices, for example, a mobile phone, a cellular phone, a handheld device, a computing device, a computer, a PC, a server computer, a client/server system, a desktop computer, a mobile computer, a portable computer, a laptop computer, a notebook computer, a tablet computer, a network of multiple inter-connected devices, a handheld computer, a handheld device, a PDA device, a handheld PDA device, an on-board device, an off-board device, a hybrid device, a vehicular device, a non-vehicular device, a mobile or portable device, a non-mobile or non-portable device, or the like.

In some demonstrative embodiments, the selection parameter may be related at least to a signal-to-noise-ratio (SNR) or a noise gain corresponding to the subset of antenna elements, e.g., as described below.

In some demonstrative embodiments, transmission 114, as received by receiver 116 using an i-th subset, i=l . . . Nsubset, of m antenna elements, may be represented as follows:

y=Hᵢ·x+n (1)

wherein x denotes a vector including l values representing l wireless signals transmitted by transmitter 106; y denotes a vector including m values representing the m wireless signals received via the m antenna elements; Hᵢ denotes a [m×l] channel matrix corresponding to a wireless transmission channel between the subset of antenna elements and antennas 110; and n denotes a vector including m values representing m respective, e.g., uncorrelated, noise signals received at the m antenna elements of receiver 116.

In some demonstrative embodiments, Equation 1 may be multiplied by Hᵢ^{H}=(Hᵢ*)^{T}, wherein * denotes a conjugate operator, and wherein ( )^{T} denotes a transpose operator, e.g., as follows:

Hᵢ^{H}·y=Hᵢ^{H}Hᵢ·x+Hᵢ^{H}·n (2)

In some demonstrative embodiments, Equation 2 may be rearranged as follows:

x=(Hᵢ^{H}Hᵢ)⁻¹Hᵢ^{H}y+N (3)

wherein N denotes the noise corresponding to the subset of antenna elements at transmitter 106 (“the noise at the transmitter plane”), e.g., as follows:

N=(Hᵢ^{H}Hᵢ)⁻¹Hᵢ·n (4)

In some demonstrative embodiments, the SNR corresponding to the noise N (“the SNR at the transmitter plane”) may be determined, for example, as follows:

$$\begin{matrix}E ( {NN}^{H} ) = E \{ {( {H}_{i}^{H} {H}_{i} )}^{- 1} {H}_{i}^{H} \cdot {n [ {( {H}_{i}^{H} {H}_{i} )}^{- 1} {H}_{i}^{H} \cdot n ]}^{H} \} \\ = E \{ {( {H}_{i}^{H} {H}_{i} )}^{- 1} {H}_{i}^{H} \cdot n \cdot {n}^{H} {{H}_{i} ( {H}_{i}^{H} {H}_{i} )}^{- H} \}\end{matrix} \qquad ( 5 )$$

In some demonstrative embodiments, Equation 5 may be rewritten as follows, e.g., if the vector n includes an uncorrelated noise vector having an equal variance, denoted σₙ, for each of the m components:

$$\begin{matrix}E ( {NN}^{H} ) = E \{ {{σ}_{n}^{2} ( {H}_{i}^{H} {H}_{i} )}^{- 1} ( {H}_{i}^{H} \cdot {I}_{mxm} \cdot {H}_{i} ) {( {H}_{i}^{H} {H}_{i} )}^{- H} \} \\ = {σ}_{n}^{2} \cdot {( {H}_{i}^{H} {H}_{i} )}^{- H} \\ = {σ}_{n}^{2} \cdot {( {H}_{i}^{H} {H}_{i} )}^{- 1}\end{matrix} \qquad ( 5.1 )$$

A noise enhancement matrix, denoted Aᵢ, resulting from MIMO matrix inversion corresponding to the i-th subset may be defined as follows:

Aᵢ=(Hᵢ^{H}Hᵢ)⁻¹ (6)

In some demonstrative embodiments, the l diagonal values of the matrix Aᵢ may correspond to a noise gain at the l antennas of transmitter 116, respectively, e.g., assuming near un-correlation between the components of the vector N.

In some demonstrative embodiments, the selection parameter, denoted pₛₑₗ_{ₗ}, corresponding to the i-th subset of antenna elements may include the noise gain at the l antennas of transmitter 116 corresponding to the i-th subset of antenna elements. For example, the selection parameter pₛₑₗ_{ₗ} may include the noise gain at the transmitter plane, which may be determined based on the matrix Aᵢ, e.g., as follows:

pₛₑₗₗ=trace[Aᵢ] (7)

wherein trace[Aᵢ] denotes the sum of the diagonal elements of the matrix Aᵢ.

In some demonstrative embodiments, the selection criterion may include selecting an j-th subset of antenna elements, denoted subsetⱼ, e.g., as follows:

subsetⱼ:trace[Aⱼ]=min(trace[Aᵢ]_{i=l . . . Nsubset}) (8)

For example, controller 126 may select the subset subsetⱼ according to Equation 8.

Reference is now made to FIG. 2, which schematically illustrates a wireless MIMO receiver 200 in accordance with some demonstrative embodiments. Although embodiments of the invention are not limited in this respect, in some demonstrative embodiments receiver 200 may perform the functionality of receiver 116 (FIG. 1).

In some demonstrative embodiments, receiver 200 may include or may be implemented as a wireless communication card, which may be attached, externally or internally, to a source module, e.g., source 108 (FIG. 1). In one non-limiting example, receiver 200 may be implemented as part of a Printed circuit board (PCB).

In some demonstrative embodiments, receiver 200 may include first and second arrays, denoted 202 and 210, respectively, of antenna elements. Antenna array 202 may include a plurality of antennas, for example, five antennas 203, 204, 205, 206 and 207; and antenna array 210 may include a plurality of antennas, for example, five antennas 211, 212, 213, 214 and 215.

In some demonstrative embodiments, antenna elements 203, 204, 205, 206 and 207 may include antenna elements of a first type, e.g., IFA elements; and antenna elements 211, 212, 213, 214 and 215 may include antenna elements of a second type, e.g., PIFA elements. In other embodiments, antenna elements 203, 204, 205, 206, 207, 211, 212, 213, 214 and/or 215 may include antenna elements of any one or more suitable types.

In some demonstrative embodiments, the antenna elements of arrays 202 and 210 may be arranged in a plurality of antenna element pairs, e.g., five antenna element pairs. For example, a first pair of antenna elements may include antenna elements 203 and 211, a second pair of antenna elements may include antenna elements 204 and 212, a third pair of antenna elements may include antenna elements 205 and 213, a fourth pair of antenna elements may include antenna elements 206 and 214, and a fifth pair of antenna elements may include antenna elements 207 and 215.

In some demonstrative embodiments, receiver 200 may also include a set of switches 220, e.g., including five switches 221, 222, 223, 224, and 225, to select a subset of five antenna elements from the antenna elements of arrays 202 and 210. In one example, each of switches 221, 222, 223, 224, and 225 may switch between an antenna element of array 202 and an antenna element of array 210. For example, switch 221 may switch between antenna elements 203 and 211, switch 222 may switch between antenna elements 204 and 212, switch 223 may switch between antenna elements 205 and 213, switch 224 may switch between antenna elements 206 and 214, and switch 225 may switch between antenna elements 207 and 215. Switches 221, 222, 223, 224, and 225 may include for example, a Single Pole Double Throw (SPDT) RF switch, a Micro-Electro-Mechanical-Systems MEMS switch, and/or any other suitable switch or selector.

In some demonstrative embodiments, switches 221, 222, 223, 224, and 225 may provide five signals 271, 272, 273, 274 and 275 received via the selected subset of five antenna elements, respectively. For example, signal 271 may include a wireless signal received via a selected antenna of antenna elements 203 and 211, signal 272 may include a wireless signal received via a selected antenna of antenna elements 204 and 212, signal 273 may include a wireless signal received via a selected antenna of antenna elements 205 and 213, signal 274 may include a wireless signal received via a selected antenna of antenna elements 206 and 214, and signal 275 may include a wireless signal received via a selected antenna of antenna elements 207 and 215.

In some demonstrative embodiments, receiver 200 may also include a RF module 230 to perform RF operations on signals 271, 272, 273, 274 and 275 and generate five respective signals 281, 282, 283, 284 and 285.

In some demonstrative embodiments, receiver 200 may also include a BB module 240 to generate output signals 299 by performing suitable BB operations on signals 281, 282, 283, 284 and 285. Signals 299 may include or may be, for example, signals 140 FIG. 1).

In some demonstrative embodiments, BB module 240 may include a controller 254 to control switches 221, 222, 223, 224, and 225, e.g., using control signals 241, 242, 243, 244, and 245, respectively. For example, controller 254 may control switches 221, 222, 223, 224, and 225 to select a subset of five antenna elements from arrays 202 and 210 based on at least one selection criterion, e.g., as described herein.

In some demonstrative embodiments, BB module 240 may also include an Automatic Gain Control (AGC) module 252, e.g., to determine a gain control corresponding to signals 281, 282, 283, 284 and 285 of the selected subset of antenna elements.

In some demonstrative embodiments, controller 254 may perform subset initialization operations to determine a plurality of values of the selection parameter relating to a plurality of predefined different subsets of antenna elements 202 and 210, wherein each of the subsets may includes a different combination five different antenna elements; and apply the selection criterion to the plurality of values to select a subset (“the selected subset”) of the plurality of subsets, e.g., as described below.

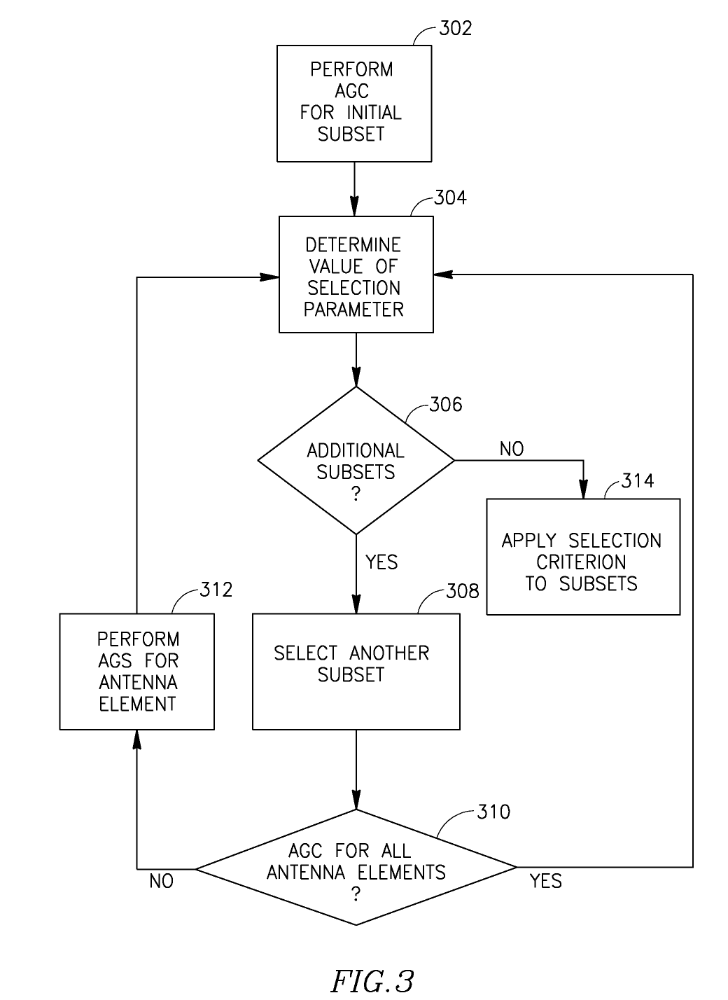

In some demonstrative embodiments, controller 254 may perform the subset initialization, for example, upon a Boot of receiver 200, and/or upon receiving an initialization instruction from a user or manager of receiver 200. For example, the subset initialization may be performed upon establishing a wireless connection with a transmitter, e.g., transmitter 106 (FIG. 1). In some demonstrative embodiments, the subset initialization may be performed in conjunction with performing AGC scaling of the antenna elements of arrays 202 and 210, e.g., as described below with reference to FIG. 3.

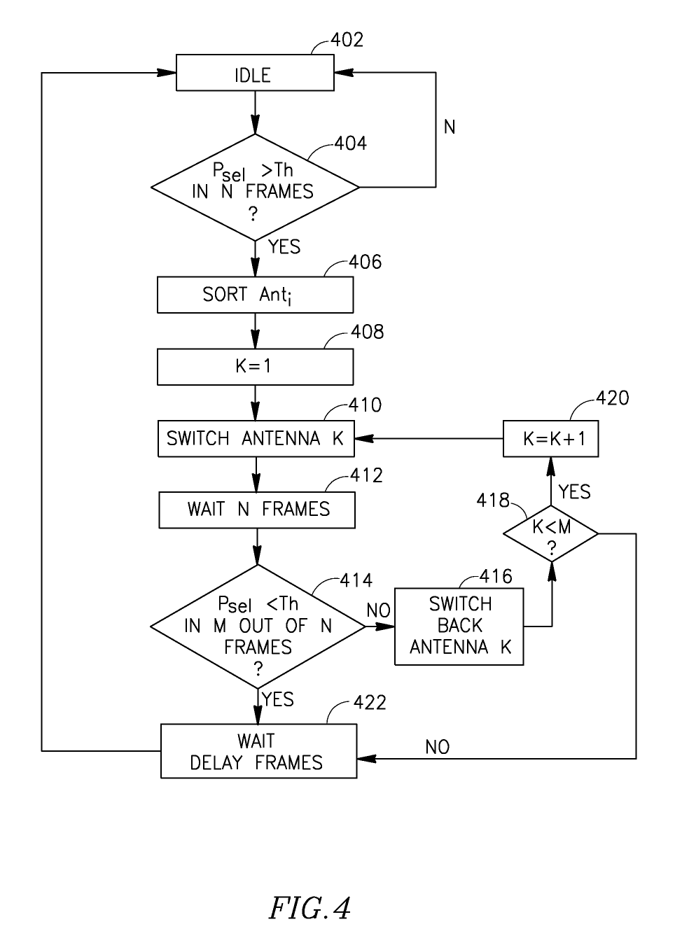

In some demonstrative embodiments, controller 254 may switch from the selected subset of antenna elements to another subset of the plurality of subsets of antenna elements, for example, if the value of the selection parameter exceeds a predefined threshold value, e.g., as described below with reference to FIG. 4.

Reference is made to FIG. 3, which schematically illustrates a method of initializing a plurality of subsets of antenna elements, in accordance with some demonstrative embodiments. Although embodiments of the invention are not limited in this respect, in some demonstrative embodiments one or more operations of the method of FIG. 3 may be performed by receiver 200 (FIG. 2) and/or controller 254 (FIG. 2).

As indicated at block 304, the method may include determining a value of the selection parameter corresponding to a subset of antenna elements (“the currently-initialized subset”) of a plurality of antenna elements. The subset of antenna elements may include, for example, m antenna elements, and the plurality of antenna elements may include, for example, n antenna elements, e.g., as described above.

In some demonstrative, embodiments the currently-initialized subset of antennas may initially include an initial subset of antenna elements. In one example, the initial subset may include m antenna elements arbitrarily selected from the n antenna elements. In another example, the initial subset may include a subset of m antenna elements, which was used in a previous transmission. In other examples, the initial subset may include any other predefined subset of antenna elements.

In some demonstrative embodiments, determining the value of the selection parameter may include determining a value related to the noise gain of the currently-initialized subset of antenna elements, e.g., the value of the parameter pₛₑₗ as described above. In some demonstrative embodiments, the value of the parameter pₛₑₗ may be determined based on an AGC adjustment corresponding to the currently-initialized subset. Accordingly, the method may also include performing the AGC adjustment corresponding to the initial subset of antenna elements, as indicated at block 302.

In some demonstrative embodiments, the AGC adjustment may be performed for each of the antenna elements of the initial subset of antenna elements during, for example, a wireless transmission frame. Accordingly, performing the AGC adjustment corresponding to the initial subset of antenna elements may last, for example, for the duration of m wireless transmission frames. For example, the AGC adjustment corresponding to an initial subset including five antenna elements may last for the duration of five wireless transmission frames.

In some demonstrative embodiments, controller 254 (FIG. 2) may control switches 221 (FIG. 2), 222 (FIG. 2), 223 (FIG. 2), 224 (FIG. 2), and 225 (FIG. 2), e.g., using control signals 241 (FIG. 2), 242 (FIG. 2), 243 (FIG. 2), 244 (FIG. 2) and 245 (FIG. 2), respectively, to select an initial subset of five antenna elements, e.g., including one of each of the five pairs of antenna elements 203 (FIG. 2), 204 (FIG. 2), 205 (FIG. 2), 206 (FIG. 2), 207 (FIG. 2), 211 (FIG. 2), 212 (FIG. 2), 213 (FIG. 2), 214 (FIG. 2) and 215 (FIG. 2). AGC module 252 may receive signals 281 (FIG. 2), 282 (FIG. 2), 283, (FIG. 2), 284 (FIG. 2), and 285 (FIG. 2) and perform the AGC adjustment corresponding to the wireless signals received via the initial subset of antenna elements, e.g., during five wireless transmission frames. Controller 254 may determine the value of the parameter pₛₑₗ corresponding to the currently-initialized subset of antenna elements, e.g., based on the AGC adjustment.

As indicated at block, 306, the method may include determining whether there are additional subsets of the plurality of subsets of antenna elements to be initialized.

As indicated at block, 308, the method may include selecting another subset of antenna elements as the currently-initialized subset, e.g., if there are additional subsets of the plurality of subsets of antenna elements to be initialized. The other subset of antenna elements may include, for example, an antenna element for which AGC adjustment has not yet been performed (“the un-adjusted antenna element”). For example, controller 254 (FIG. 2) may control switches 221 (FIG. 2), 222 (FIG. 2), 223 (FIG. 2), 224 (FIG. 2), and/or 225 (FIG. 2), e.g., using control signals 241 (FIG. 2), 242 (FIG. 2), 243 (FIG. 2), 244 (FIG. 2) and/or 245 (FIG. 2), respectively, to select another subset of five antenna elements, e.g., including one of each of the five pairs of antenna elements 203 (FIG. 2), 204 (FIG. 2), 205 (FIG. 2), 206 (FIG. 2), 207 (FIG. 2), 211 (FIG. 2), 212 (FIG. 2), 213 (FIG. 2), 214 (FIG. 2) and 215 (FIG. 2).

As indicated at block 310, the method may include determining whether AGC adjustment has been performed for all antenna elements of the currently-initialized subset of antenna elements. As indicated at block 304, the method may include determining the value of the selection parameter corresponding to the currently-initialized subset, e.g., if AGC adjustment has been performed for all antenna elements of the currently-initialized subset of antenna elements. For example, controller 254 may determine the value of the parameter pₛₑₗ corresponding to the currently-initialized subset of antenna elements, e.g., based on the AGC adjustment.

As indicated at block 312, the method may include performing the AGC adjustment corresponding to the unadjusted antenna element. For example, AGC module 252 (FIG. 2) may perform the AGC adjustment corresponding to the unadjusted antenna element, e.g., during the duration of a succeeding wireless transmission frame.

In some demonstrative embodiments, the operations of blocks 304, 306, 308, 310 and 312 may be repeated, e.g., until the plurality of values of the selection parameter, e.g., the noise gain, are determined for the plurality of subsets, respectively.

As indicated at block 314, the method may include selecting a subset of the plurality of subsets of antenna elements, for example, by applying the predefined selection criterion to the plurality of values of the selection parameter. For example, controller 254 (FIG. 2) may select the subset of antenna elements according to Equation 8. In other embodiments, controller 254 (FIG. 2) may select the subset of antenna elements based on any other suitable selection criterion.

In some demonstrative embodiments, the operations of the method of FIG. 3 may last, for example, for the duration of m−1+2m wireless transmission frames, e.g., if the plurality of subsets of antenna elements include 2m subsets, each including m antenna elements. For example, controller 254 (FIG. 2) may initialize the plurality of subsets of five antenna elements, during 5−1+2⁵=37 frames, e.g., if each subset includes an antenna element of antenna elements 203 (FIG. 2) and 211 (FIG. 2), an antenna element of antenna elements 204 (FIG. 2) and 212 (FIG. 2), an antenna element of antenna elements 205 (FIG. 2) and 213 (FIG. 2), an antenna element of antenna elements 206 (FIG. 2) and 214 (FIG. 2), and an antenna element of antenna elements 207 (FIG. 2) and 215 (FIG. 2)

Reference is made to FIG. 4, which schematically illustrates a method of switching between subsets of antenna elements, in accordance with some demonstrative embodiments. Although embodiments of the invention are not limited in this respect, in some demonstrative embodiments one or more operations of the method of FIG. 4 may be performed by receiver 200 (FIG. 2) and/or controller 254 (FIG. 2), for example, to switch from a first subset of antenna elements to a second subset of antenna elements.

As indicated at block 402, the method may include using the first subset of antenna elements to receive wireless MIMO transmissions, e.g., during an idle reception state of operation. For example, receiver 200 (FIG. 2) may use the selected subset of antenna elements, e.g., after performing the subset initialization of the plurality of subsets of antenna elements as described above.

As indicated at block 404, the method may include determining whether the value of the selection parameter, e.g., the value of the parameter pₛₑₗ, corresponding to the first subset of antenna elements exceeds a predefined threshold value, denoted Th, e.g., during a predefined number, denoted N, of wireless transmission frames. For example, controller 254 (FIG. 2) may monitor the value of the parameter pₛₑₗ, e.g., continuously, and compare the value of the parameter pₛₑₗ to the threshold value.

As indicated at block 406, the method may include sorting the antenna elements of the first antenna subset, e.g., according to an average square error, denoted σ², of the error corresponding to each of the antennas. For example, controller 254 (FIG. 1) may sort the five antenna elements of the first subset of antenna elements such that σ₁²>σ₂²>σ₃²>σ₄²>σ₅², wherein σⱼ², j=1 . . . m, denotes the average square error of the antenna element having the j-th highest average square error.

In some demonstrative embodiments, the method may include switching between the antenna element having the highest value of σ² and another antenna element not included ion the first subset; switching between the antenna element having the second-highest value of σ² and another antenna element not included ion the first subset, e.g., if the value of the parameter pₛₑₗ still exceeds the threshold value, and so on, e.g., as described below.

As indicated at block 408, the method may include setting a value of a counter, denoted k, e.g., to k=1.

As indicated at block 410, the method may include switching between the k-th antenna element of the set of sorted antenna elements and another antenna element of the set of n antenna elements to result in a second subset of antenna elements. For example, controller 254 (FIG. 2) may control switches 220 to switch between the k-th antenna element and the other antenna element, e.g., as described above with reference to FIG. 2.

As indicated at block 412, the method may include monitoring the value of the parameter Psel, e.g., during N additional transmission frames.

As indicated at block 414, the method may include determining whether the value of the parameter Psel corresponding to a predefined number, denoted M, of the N additional frames is smaller than the threshold value. As indicated at block 422, the method may include, for example, using the second subset of antenna elements, e.g., after waiting a predefined delay time period, for example, if the parameter Psel corresponding to the M frames is smaller than the threshold value.

As indicated at block 416, the method may include switching back between the other antenna element and the k-th antenna element, to switch back to the first subset of antennas.

As indicated at block 418, the method may include determining whether all m antennas of the first subset have already been switched, for example, by determining whether the counter k has reached the value of m.

As indicated at block 420, the method may include increasing the counter k by one, and performing the operations of blocks 410, 412, 414, 416 and/or 418 with relation to the next k-th antenna element.

Some embodiments may be implemented by software, by hardware, or by any combination of software and/or hardware as may be suitable for specific applications or in accordance with specific design requirements. Some embodiments may include units and sub-units, which may be separate of each other or combined together, in whole or in part, and may be implemented using specific, multi-purpose or general processors, or devices as are known in the art. Some embodiments may include buffers, registers, storage units and/or memory units, for temporary or long-term storage of data and/or in order to facilitate the operation of a specific embodiment.

While certain features have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. An apparatus comprising a wireless receiver to receive a multiple-input-multiple-output wireless transmission, the receiver comprising:
a set of antenna elements having different polarizations to receive a respective set of wireless signals of said multiple-input-multiple-output wireless transmission over a respective set of different communication channels, wherein said set of antenna elements includes a first number of antenna elements;
a radio-frequency module to handle a second number of wireless received signals, wherein said second number is smaller than said first number; and
a selector to selectively provide said radio-frequency module with a subset of said set of wireless signals including said second number of signals according to at least one selection criterion.

2. The apparatus of claim 1, wherein said selector is capable of determining a plurality of values of a predefined parameter relating to a plurality of subsets of said set of antenna elements, respectively, wherein each of said subsets includes said second number of antenna elements; and selecting a subset of said plurality of subsets by applying said selection criterion to said plurality of values.

3. The apparatus of claim 2, wherein said selector is capable of selecting another subset of said plurality of subsets of antenna elements, if the value of said parameter exceeds a predefined threshold value.

4. The apparatus of claim 1, wherein said set of antenna elements includes a plurality of pairs of antenna elements, and wherein said selector comprises a plurality of switches to switch between the antenna elements of said plurality of pairs of antenna elements, respectively.

5. The apparatus of claim 4, wherein said receiver comprises a controller to control said set of switches based on said at least one selection criterion.

6. The apparatus of claim 5, wherein said controller is capable of determining a plurality of values of a predefined parameter relating to a plurality of subsets of said set of antenna elements, respectively, wherein each of said subsets includes said second number of antenna elements; selecting a subset of said plurality of subsets by applying said selection criterion to said plurality of values; and controlling said set of switches to switch to the selected subset of antenna elements.

7. The apparatus of claim 1, wherein said set of antenna elements comprises a first antenna array including a plurality of antenna elements of a first type, and a second antenna array including a plurality of antenna elements of a second type.

8. The apparatus of claim 7, wherein each of said first and second antenna arrays includes said second number of antenna elements, and
wherein said selector comprises a set of switches, each of said switches to switch between an antenna element of said first antenna array and an antenna element of said second antenna array.

9. The apparatus of claim 7, wherein said first antenna array includes a plurality of printed inverted-F-antenna-elements, and wherein said second antenna array includes a plurality of planar-inverted-f-antenna elements.

10. The apparatus of claim 1, wherein said at least one selection criterion is related to at least a noise gain of said subset of wireless signals.

11. The apparatus of claim 1 comprising a display to display an image corresponding to said multiple-input-multiple-output wireless transmission.

12. A method of receiving a multiple-input-multiple-output wireless transmission, the method comprising:
receiving a set of wireless signals of said multiple-input-multiple-output wireless transmission over a respective set of different communication channels via a respective set of antenna elements, wherein said set of antenna elements comprises a first number of antenna elements having different polarizations;
selecting a subset of said set of wireless signals including a second number of signals according to at least one selection criterion; and
providing a radio-frequency module with said subset of wireless signals.

13. The method of claim 12, wherein said selecting comprises:
determining a plurality of values of a predefined parameter relating to a plurality of different subsets of said set of antenna elements, respectively, wherein each of said subsets includes said second number of antenna elements; and
applying said selection criterion to said plurality of values.

14. The method of claim 13 comprising switching from a selected subset of said plurality of subsets of antenna elements to another subset of said plurality of subsets of antenna elements, if the value of said parameter exceeds a predefined threshold value.

15. The method of claim 13, wherein said parameter relates to a noise gain of said subsets.

16. The method of claim 12, wherein said set of antenna elements includes a plurality of pairs of antenna elements, and wherein said selecting comprises switching between first and second antenna elements of one or more of said pairs of antenna elements.

17. The method of claim 12, wherein said set of antenna elements comprises a first antenna array including a plurality of antenna elements of a first type, and a second antenna array including a plurality of antenna elements of a second type.

18. The method of claim 17, wherein a first half of said subset of antenna elements comprises antenna elements of said first type, and a second half of said subset of antenna elements comprises antenna elements of said second type.

19. The method of claim 17, wherein said first antenna array includes a plurality of printed inverted-F-antenna-elements, and wherein said second antenna array includes a plurality of planar-inverted-f-antenna elements.

20. A system comprising:
a transmitter to transmit a multiple-input-multiple-output wireless transmission; and
a receiver to receive said wireless transmission, wherein said receiver comprises:
a set of antenna elements having different polarizations to receive a respective set of wireless signals of said wireless transmission over a respective set of different communication channels, wherein said set of antenna elements includes a first number of antenna elements;
a radio-frequency module to handle a second number of wireless received signals, wherein said second number is smaller than said first number; and
a selector to selectively provide said radio-frequency module with a subset of said set of wireless signals including said second number of signals according to at least one selection criterion.

21. The system of claim 20, wherein said selector is capable of determining a plurality of values of a predefined parameter relating to a plurality of subsets of said set of antenna elements, respectively, wherein each of said subsets includes said second number of antenna elements; and selecting a subset of said plurality of subsets by applying said selection criterion to said plurality of values.

22. The system of claim 20, wherein said set of antenna elements includes a plurality of pairs of antenna elements, and wherein said selector comprises a plurality of switches to switch between the antenna elements of said plurality of pairs of antenna elements, respectively.

23. The system of claim 20, wherein said set of antenna elements comprises a first antenna array including a plurality of antenna elements of a first type, and a second antenna array including a plurality of antenna elements of a second type.

24. The system of claim 20 comprising:
a video source associated with said transmitter to generate video data, wherein said wireless video transmission represents said video data; and
a display associated with said receiver to display an image corresponding to said video data.
